(19) United States
(12) Patent Application Publication
(10) Pub. No.: US 2007/0159559 A1
(43) Pub. Date: Jul. 12, 2007

(54) Method to switch on-off and the stand-by operation of a projection television

(75) Inventors: Wen-Chih Tai, Padeh City (TW); Chia-Lin Liu, Padeh City (TW); Chi-Neng Mo, Padeh City (TW)

Correspondence Address: BIRCH STEWART KOLASCH & BIRCH, PO BOX 747, FALLS CHURCH, VA, 22040-0747, US

(73) Assignee: CHUNGHWA PICTURE TUBES, LTD

(21) Appl. No.: 11/328,159

(22) Filed: Jan. 10, 2006

(51) Int. Cl. H04N 5/74

(52) U.S. Cl. 348/748

(57) ABSTRACT

A fast control method controls the time of switch on-off and the stand-by operation of a projection television. The method with control units including state-assigned flags, state-completed flags and delay of a time control unit quickly carries out state transformations of the system to shorten the period turning on/off the system and to prevent the system from suffering.

### BACKGROUND OF THE INVENTION

1. Field of the Invention

The present invention relates to a method, especially, to a method using control unit with state flags to control switch-on/off and stand-by operations of a projection television.

2. Background of the Related Art

A projection television includes mainly a power supply, a display, a lamp, fans and their control units. The power supply provides the power, and images show on the display, and the lamp provides the display with light, and the fan take out the heat from the lamp. The off mode of a television is a stand-by or waiting mode but a real off state. During the stand-by or waiting mode of a projection television, an infrared control unit is supplied with current by a stand-by circuit portion, that is, the power supplier supplies with part current to the stand-by circuit portion to switch on projection television.

The shock wave occurs as user switches on the projection television, and the shock wave suffers the machine. The procedure to switch on the projection television needs a delay to steady the current and subsequently switches on lamp and fan.

The lamp generates much heat as it radiates light. The fan is responsible for removing the heat during the operation and remains running for a period to avoid suffering the system from the high temperature.

Users often mistake the power button in manipulating the system, and the system will shut down consequentially. User has to wait for a long time till the off procedure finishes and turns it on again. It suffers user's impression on the product severely and wastes user's life.

Prior art provides two-phase switching off procedure. The video display shuts down for two periods. During the first period, the system turns off the display but the lamp, fans and circuit remain energized. In this interval, the user's order is granted, that is, the user presses another button will trigger the video display to reinitiate. After the delay of the first period, the second period starts, and the user's order will be discarded. That is, the lamp, fans and circuits are de-energized in second period, and the user waits for the time to shut down only.

Another prior art provides a timer switch, and the timer switch turns off the system after a specified period, that is, the timer switch transforms the stand-by mode to off mode of a television. The user has to switch on the power supply manually after the system shuts down due to the power supplier does not provide power.

Another prior art developes a procedure to cool quickly the lamp of a television as the system shuts down. The system remains running for a period as the user turns off the system. During the time interval, maybe 5 minutes, the lamp is de-energized but the fan speeds up to remove rapidly the heat of the lamp till the temperature falls down to a specified temperature. The center control unit handles the whole procedure. It will not continue the procedure if the center control unit enters a subroutine with bugs.

It still is a main subject to provide a method to shorten the time interval to shut down, to cope with the user's mistaking order and to redeem the procedure from user's regret for turn-off order on a projection television.

### SUMMARY OF THE INVENTION

This present invention provides a method to switch on/off and the stand-by operation of a projection television to solve the problems mentioned above. Each unit of the system is taken a subsystem with an independent control unit to avoid a bug generated by some subroutine to obstruct the procedure. The independent control unit has a state-completed flag indicating whether the control unit completes assigned state or not. The system precedes the procedure to switch on-off and stand-by operations according to the state-completed flags of the system.

A projection television includes a plurality of state-assigned flags, state-completed flags and switches corresponding to button control unit, power control unit, lamp control unit, heat-dispersant control unit and television procedure control unit, and switches implemented by electrical circuit or software programs. Each state-assigned flag indicates the assigned state, and the flag-completed flag indicates whether the assigned state is finished or not, and the switch executes specified actions.

The television procedure control unit includes further a timer control unit except the control unit includes, and the timer control unit is also a control unit. The timer control unit supplies a delay to complete an action of a control unit. Switching on the projection television needs the delay to steady the voltage and switching off needs the delay to remove the heat generated by the lamp of the projection television, that is why the system has to have the timer control unit.

The television procedure control unit checks the state-completed flags of the control unit and timer control unit to perform actions according to a predetermined priority of the flags designed validly to conciliate the on-off and stand-by operations of a projection television.

### BRIEF DESCRIPTION OF THE DRAWINGS

FIG. 1 shows a block diagram of a projection television according to an embodiment of the present invention.

FIG. 2 shows a main flow chart according to an embodiment of the present invention.

FIG. 3 shows a flow chart to switch on the system according to an embodiment of the present invention.

FIG. 4 shows a flow chart to switch off the system according to an embodiment of the present invention.

### DETAILED DESCRIPTION OF THE INVENTION

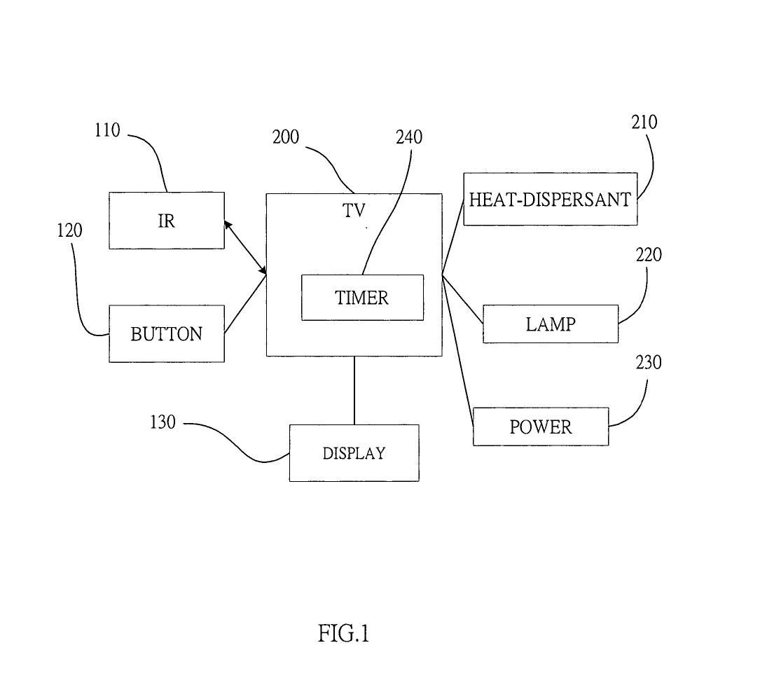

FIG. 1 shows a block diagram to explain the relationship of the different units of a projection television. The Infrared control unit (denoted IR) 110 is connected wirelessly to and the button control unit (denoted BUTTON) 120 is connected electrically to the television procedure control unit (denoted TV) 200, and the IR 110 and the BUTTON 120 provide the user operative interface. A display handled by display control unit (denoted DISPLAY) 130 connected to the TV 200 shows the image, and the lamp controlled by lamp control unit (denoted LAMP) 220 provides the display with light, and the heat dispersant controlled by heat-dispersant control unit (denoted HEAT-DISPERSANT) 210 removes the heat generated by the lamp. A power button on the BUTTON 120 or on the IR 110 is pressed to trigger the transformation from a state to another state indicated by a state-assigned flag, and the power supplier controlled by the power control unit (denoted POWER) 230 supplies power to projection television. TV 200 switches on or off HEAT-DISPERSANT 210, LAMP 220 and POWER 230 by a predetermined order as the power key is pressed to start a new transformation.

Each control unit among IR 110, BUTTON 120, DISPLAY 130, HEAT-DISPERSANT 210, LAMP 220 and POWER 230 includes a state-assigned (denoted OnOff) flag, a state-completed (denoted OnOffOk) flag and a switch. TV 200 includes further a timer control unit (called TIMER) 240 except the control unit aforementioned includes, and TIMER 240 is also a control unit.

The state-assigned flag includes two exclusive states “ON” indicating on state and “OFF” indicating the off state of the correspondent control unit. The state-completed also includes two exclusive values “OK” and “!OK” (pronounced not OK) indicating whether the assigned state complete or not. SWITCH implemented by a circuit or by a software program executes specified actions. TIMER 240 provides the delay. The state-completed flag of TIMER is OK to indicate the delay is complete and !OK to be not complete.

A projection television includes two stable states one is on state and the other off state represented by ON and OFF of the state-assigned flag of the TV 200 respectively as its state-completed is OK. A projection television also includes two transformations switching on transforming from off to on state and switching off transforming from on to off state, and the power button on the IR 110 or on the BUTTON 120 is pressed to trigger those transformations, and the projection television is in a transformation as the state-completed flag of TV 200 is !OK. TV 200 checks recursively whether the power button is pressed or not in a stable state, and checks recursively state-completed flag of TV 200 presenting OK or !OK in a transformation.

The goal of the delay is to prevent the system, especially the lamp, from suffering. Switching on procedure delays turning on the lamp and the heat dissipative system for a specified time interval after the power starts, and the voltage on the system reaches the stable state during the time interval. Similar to the switching on procedure, switching off procedure delays turning off the heat dissipative system for an interval after the power and lamp shuts down, and the heat dissipative system cools the lamp to a given temperature during the interval. In generally the lamp is a light bubble, and it will reach very high temperature as it radiates. Fans to take the heat away from the light bubble implement the heat dissipative system. Controlling the speed of the fans controls the heat-dissipative rate.

A main recursion is responsible for checking whether the power button is pressed in a stable state or not and verifying the state-completed flag of TV 200 in a transformation. Switching on and Switching off are responsible for turning on and off the units of the system in a predetermined order and setting the state-completed flag, and TV 200 determines the transformation is complete or not by verifying the state-completed flag.

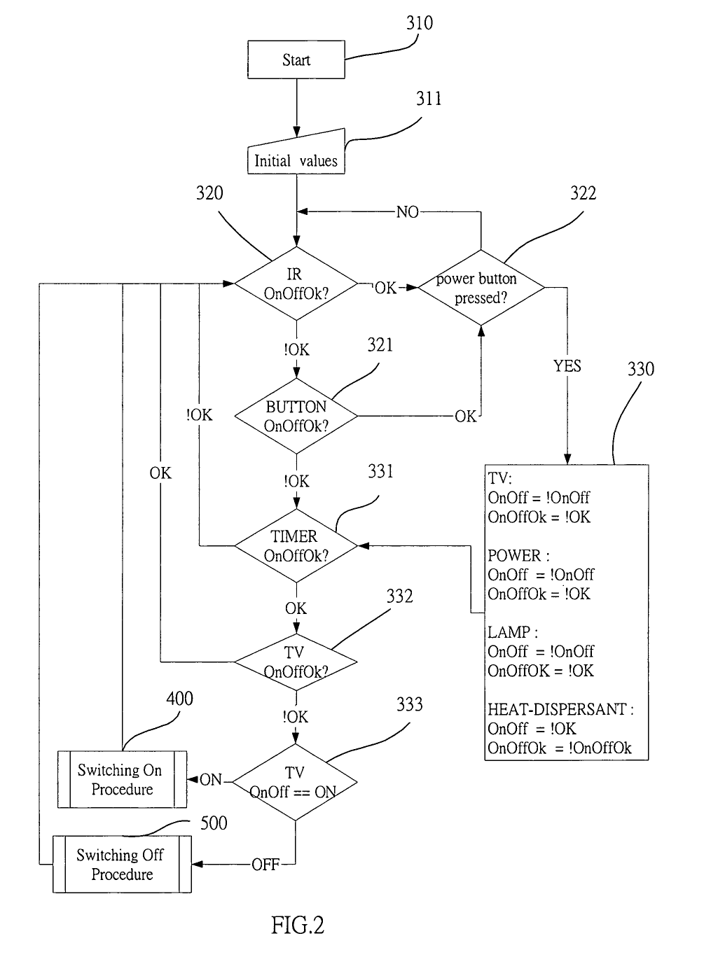

FIG. 2 shows the main flow illustrating the main recursion according to an embodiment of the present invention.

Referred to step 310, the system starts, and the system is initiated in step 311.

Referred to step 320 and 321, TV verifies the state-completed flags of IR and BUTTON. OK means the system is in a stable state and !OK in a transformation.

Referred to step 322, TV checks whether the power button is pressed or not in a stable state. YES indicates the power button is pressed and the system will enter a transformation. NO indicates the system stays still in a stable state.

Referred to step 330, TV triggers the control units of the system set state-assigned (OnOff) flag and state-completed (OnOffOk) flag as the system will enter a transformation. The values of state-assigned flags of the control units are set oppositely to the origin value (expressed OnOff=!OnOff). The values of the state-completed flags of the control units are set to !OK (expressed OnOffOk=!OK), and it means the system does not reach the assigned state.

Referrer to step 331, TV checks the OnOffOk flag of TIMER as the system is in a transformation. OK means the delay is complete, and !OK means the system waits for completing the delay.

Referrer to step 332, TV checks OnOffOk flag of itself as the delay is complete. The system enters a stable state as the value is OK, and the system starts a transformation as the value is !OK.

Referrer to step 333, TV reads the value of the OnOff flag of TV as the system starts a transformation. The system enters the switching on procedure as the value is ON, and enters the switching off procedure as the value is OFF.

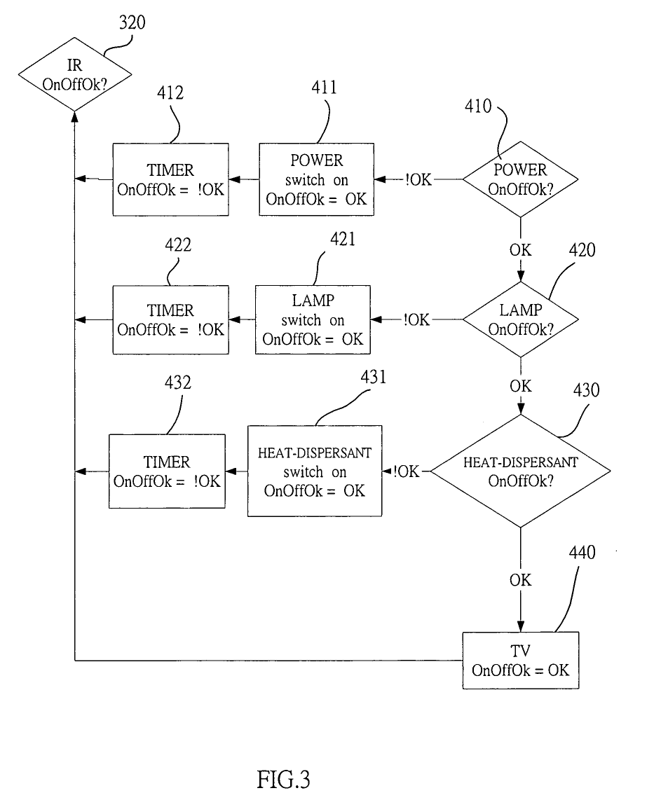

FIG. 3 shows a flow chart illustrating the switching on procedure according to an embodiment of the present invention. The procedure turns on POWER, LAMP and HEAT-DISPERSANT sequentially.

Referred to step 410, POWER verifies the OnOffOk flag. OnOffOk=OK means POWER has been turned on and it continues to turn on LAMP. OnOffOk=!OK means POWER starts turning on.

Referred to step 411, POWER sets OK to OnOffOk flag, and subsequently switches on the lamp, and subsequently triggers TIMER to start.

Referred to step 412, TIMER sets !OK to OnOffOk flag, and subsequently starts to count time for a delay, and subsequently sets OK to OnOffOk flag after the delay is complete.

Referred to step 420, LAMP verifies the OnOffOk flag. OnOffOk=OK means LAMP has been turned on and it continues to turn on HEAT-DISPERSANT. OnOffOk=!OK means LAMP starts turning on.

Referred to step 421, LAMP sets OK to OnOffOk flag, and subsequently switches on the lamp, and subsequently triggers TIMER to start.

Referred to step 422, TIMER sets !OK to OnOffOk flag, and subsequently starts to count time for a delay, and subsequently sets OK to OnOffOk flag after the delay is complete.

Referred to step 430, HEAT-DISPERSANT verifies the OnOffOk flag. OnOffOk=OK means HEAT-DISPERSANT has been turned on and it continues to set OK to the OnOffOk flag of TV. OnOffOk=!OK means HEAT-DISPERSANT starts turning on.

Referred to step 431, HEAT-DISPERSANT sets OK to OnOffOk flag, and subsequently switches on the heat dissipative system, and subsequently triggers TIMER to start.

Referred to step 432, TIMER sets !OK to OnOffOk flag, and subsequently starts to count time for a delay, and subsequently sets OK to OnOffOk flag after the delay is complete.

Referred to step 440, HEAT-DISPERSANT sets OK to OnOffOk flag of TV as TIMER completes its delay, and TV sets OK to OnOffOk flag of BUTTON and IR. It means the switching on procedure is complete and the system enters a running state (or called on state).

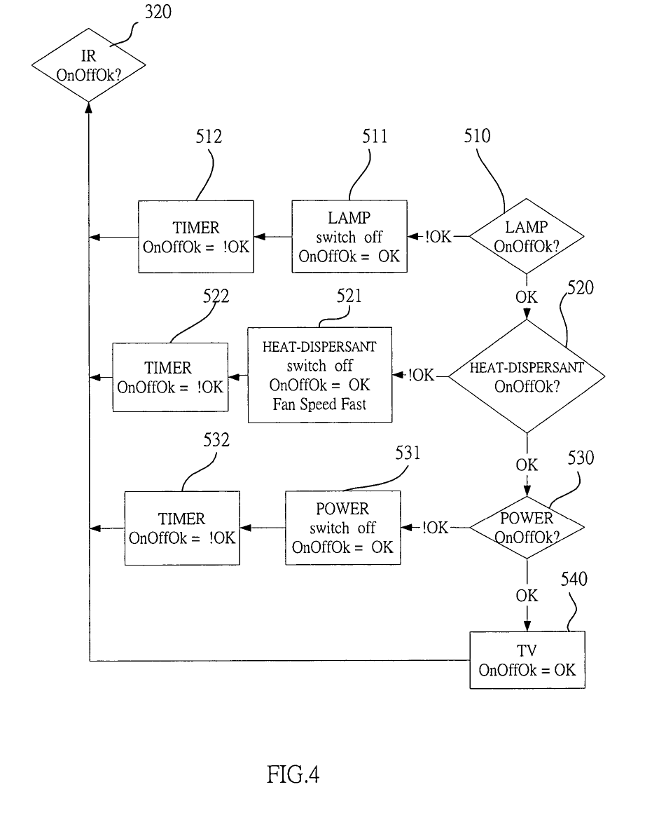

FIG. 4 shows a flow chart illustrating the switching off procedure according to an embodiment of the present invention. The procedure turns on LAMP, HEAT-DISPERSANT and POWER sequentially.

Referred to step 510, LAMP verifies the OnOffOk flag. OnOffOk=OK means LAMP has been turned off and it continues to turn off HEAT-DISPERSANT. OnOffOk=!OK means LAMP starts turning off.

Referred to step 511, LAMP sets OK to OnOffOk flag, and subsequently switches on the lamp, and subsequently LAMP triggers TIMER to start.

Referred to step 512, TIMER sets !OK to OnOffOk flag, and subsequently starts to count time for a delay, and subsequently sets OK to OnOffOk flag after the delay is complete.

Referred to step 520, HEAT-DISPERSANT verifies the OnOffOk flag. OnOffOk=OK means HEAT-DISPERSANT has been turned off and it continues to turn off POWER. OnOffOk=!OK means HEAT-DISPERSANT starts turning off.

Referred to step 521, HEAT-DISPERSANT sets OK to OnOffOk flag, and subsequently switches on the heat dissipative system, and subsequently triggers TIMER to start. During the delay, to speed the heat dissipative system up removes the heat quickly, and cools down to a given temperature, which user can switch on the system immediately.

Referred to step 522, TIMER sets !OK to OnOffOk flag, and subsequently starts to count time for a delay, and subsequently sets OK to OnOffOk flag after the delay is complete.

Referred to step 530, POWER checks the OnOffOk flag. OnOffOk=OK means POWER has been turned off and it continues to set OK to the OnOffOk flag of TV. OnOffOk=!OK means POWER starts turning off.

Referred to step 531, POWER sets OK to OnOffOk flag, and subsequently turns off power gradually, and subsequently triggers TIMER to start.

Referred to step 532, TIMER sets !OK to OnOffOk flag, and subsequently starts to count time for a delay, and subsequently sets OK to OnOffOk flag after the delay is complete. During the delay, the system could show messages on screen to hint user the process of the system.

Referred to step 540, POWER sets OK to OnOffOk flag of TV as TIMER completes its delay, and TV sets OK to OnOffOk flag of BUTTON and IR. It means the switching off procedure is complete and the system enters a shutdown state (or called off state).

The delay of the switching off procedure is long enough to cool down to a given temperature, which user can start the system again immediately, or user can press other button to restore state from the transformation during the delay.

Although the present invention has been explained in relation to its preferred embodiment, it is to be understood that other modifications and variation can be made without departing the spirit and scope of the invention as claimed.

What is claimed is:

1. A control system applied in projection television, said control system comprising:
a television procedure control unit, said television control unit including a timer control unit for counting delay time;
a button control unit connected to said television procedure control unit;
a lamp control unit connected to said television procedure control unit;
a heat dispersant control unit connected to said television procedure control unit;
a power control unit connected to said television procedure control unit;
a plurality of state-assigned flags corresponding to said television procedure control unit, said button control unit, said lamp control unit, said heat dispersant control unit and said power control unit, wherein each of said state-assigned flags corresponding to each of said control units respectively indicates the assigned state of each of said correspondent control units; and
a plurality of state-completed flags corresponding to said television procedure control unit, said button control unit, said lamp control unit, said heat dispersant control unit and said power control unit, wherein each of said state-completed flags corresponding to each of said control units indicates whether the correspondent control unit reaches the assigned state;
wherein said television procedure control unit transforms said lamp control unit, heat dispersant control unit and power control unit in a predetermined order, guided by said timer control unit and said plurality of state-completed flags, to reach the assigned state as button control unit is driven.

2. The control system applied in projection television according to claim 1, wherein each of said state-assigned flags comprises an “ON” and an “OFF” modes indicating the turning on and off states of said correspondent control unit respectively.

3. The control system applied in projection television according to claim 1, wherein each of said state-completed flags comprises an “OK” and an “!OK” modes indicating a stable state and a transformation of said correspondent control unit respectively.

4. The control system applied in projection television according to claim 1, wherein said projection television further comprises an infrared (IR) control unit to drive said transformations.

5. The control system applied in projection television according to claim 1, wherein said projection television further comprises a display control unit.

6. The control system applied in projection television according to claim 5, wherein said display control unit is a liquid crystal display control unit.

7. The control system applied in projection television according to claim 1, wherein said projection television further comprises a plurality of switches corresponding to said control units to execute said transformations, respectively.

8. The control system applied in projection television according to claim 1, wherein said heat dispersant control unit is a fan control unit.

9. A control method applied to a projection television including a plurality of control units including button, heat dispersant, lamp and power control units and a television procedure control unit, said control method comprising:
setting a plurality of state-assigned flags and a plurality of state-completed flags, wherein each of said state-assigned flags and each of said state-completed flags are corresponding to each of said control units, respectively;
checking whether said power control unit is driven or not;
setting a non-completed mode to each of said state-completed flags respectively and setting an assigned target mode to each of said state-assigned flags as said power control unit is driven; and
doing at least a predetermined procedure to reach the assigned target states according to said assigned target modes of said plurality of state-completed flags as said state-completed flags are in said non-completed mode.

10. The control method according to claim 9, wherein said predetermined procedure is a switching on procedure, and turns on such said control units according to a given order in said switching on procedure.

11. The control method according to claim 10, wherein said switching on procedure comprises a delay as said control unit turns on.

12. The control method according to claim 9, wherein said predetermined procedure is a switching off procedure, and turns off such said control units according to a given order in said switching off procedure.

13. The control method according to claim 12, wherein said switching off procedure comprises a delay as said control unit turns off.

14. The control method according to claim 13, wherein heat dispersant speeds up during said delay as said heat dispersant control unit turns off.

15. The control method according to claim 13, wherein said switching off procedure stops to restore a running state as the other button on the button control unit is driven during said delays.

16. The control method according to claim 9, wherein said predetermined procedure is a stand-by procedure, and verifies said state-completed flags corresponding to said control units.

17. A control method according to claim 9, wherein said control units set a completed mode to said state-completed flags after said control units act.
